(19) United States
(12) Patent Application Publication
(10) Pub. No.: US 2023/0229119 A1
(43) Pub. Date: Jul. 20, 2023

(54) ROBOTIC PROCESS AUTOMATION (RPA)-BASED DATA LABELLING

(71) Applicants: Baidu USA, LLC, Sunnyvale, CA (US); Baidu.com Times Technology (Beijing) Co., Ltd., Beijing (CN)

(72) Inventors: Huimeng ZHENG, Beijing (CN); Haofeng KOU, Palo Alto, CA (US)

(73) Assignees: Baidu USA LLC, Sunnyvale, CA (US); Baidu.com Times Technology (Beijing) Co., Ltd., Beijing (CN)

(21) Appl. No.: 18/009,976

(22) PCT Filed: Feb. 10, 2021
(86) PCT No.: PCT/CN2021/076582

§ 371 Date: Dec. 12, 2022

(51) Int. Cl. G05B 13/02; G06N 20/00

(52) U.S. Cl. CPC G05B 13/0265; G06N 20/00

(57) ABSTRACT

One application of deep learning methods and labelled data is for industrial production or work applications. For such applications implemented with machine learning applications, massive amounts of data are required to train, validate, and/or tune models for better fitting the requirements. However, obtaining such data has typically be costly and difficult. Embodiments provide adaptable processes that provide data labelling methods for work settings. Embodiments take advantage of the work or production processes to label and collect data, which save time and money and improves accuracy. Embodiments prevent or reduce the need for worker training costs and human mistake-triggered data labelling problems. Embodiments also improve data labelling quality and speed-up of the development cycle.

### BACKGROUND

### A. Technical Field

The present disclosure relates generally to systems and methods for computer learning that can provide improved computer performance, features, and uses. More particularly, the present disclosure relates to systems and methods for dataset generation and supervised learning.

### B. Background

Machine learning has achieved great successes in many domains, such as computer vision, natural language processing, recommender systems, etc. A major trend in machine learning is the study of computer methods that improve automatically through experience. One area of machine learning deals with methods build upon models that are trained using labelled data, in order to make predictions or decisions without being explicitly programmed to do so. The use of labelled, ground-truth data in training is referred to as supervised learning.

Similarly, deep learning refers to a broad family of machine learning methods based on artificial neural networks. Many deep learning approaches also heavily depend on labelled data.

One of the biggest challenges to machine learning methods that employ labelled data is obtaining the labelled data. Generating labelled datasets can be quite expensive and labor intensive. Typically, generating a labelled dataset involves a process of detecting and tagging data samples. Often, this labelling process is done by humans. Sometimes the labelling process may be performed or at assisted by software; but even in those cases, it often also requires significant manual labor.

Accordingly, what is needed are improved systems and methods for generating labelled data and improved systems and methods for deploying trained models.

### BRIEF SUMMARY

As noted above, improved systems and methods for generating labelled data and for deploying trained models are needed. Presented herein are systems, methods, and computer-readable media comprising instructions for methods that perform the following methods.

In one or more embodiments, a method comprises: for each element of a plurality of elements of interest: capturing, using one or more sensors configured in a work setting, sensor data comprising one or more values of the element of interest; and associating a classification label with the element of interest, in which the classification label is determined by one or more workers in a course of the one or more workers performing their normal duties in the work setting. In one or more embodiments, a label may be associated with element or item of interest according to which sensor captures data about the element of interest.

A labelled dataset may be formed using the captured sensor data and associated labels. In one or more embodiments, at least some of the labelled dataset may be used to train a machine learning model to perform classification on elements of interest. In one or more embodiments, the trained machine learning model may be deployed in a same or similar work setting to automate classification of elements of interest. In one or more embodiments, if a machine learning model does not achieve an accuracy above a threshold value given the existing labelled dataset, additional labelled data may be collected and/or used to validate the machine learning model and to perform additional training on the machine learning model using at least some of the additional labelled data. If the machine learning model achieves accuracy above the threshold value, it may be deployed to automate classification of elements of interest.

In one or more embodiments, data may be collected from a plurality of work settings, in which the workers operate on elements of interest that are of a same type and perform a same classification operation. Thus, a plurality of labelled datasets may be created using the captured sensor data and associated labels from the one or more worker's classifications. In one or more embodiments, for each work setting of a set of work settings selected from the plurality of work settings, at least some of the labelled dataset associated with the work setting can be used to train a machine learning model to perform classification on elements of interest.

In one or more embodiments, a plurality of machine learning models formed using different labelled datasets may be collected or obtained, and a set of combined models comprising a combination of two or more of the machine learning models may be formed. Using evaluation data to obtain accuracy measures for each combined model, a combined model with an acceptable accuracy measure may be selected and deployed at one or more work settings.

In one or more embodiments, labelled data from at least two work settings may be combined to form a superset of labelled data. Such a dataset may help improve robustness in training a machine learning model.

In one or more embodiments, a method for training a machine learning model comprises: obtaining training data comprising, for each training data entry, input data about an element and corresponding ground-truth data for a desired output; and using the training data to train a machine learning model to operate on input data corresponding to the data about an element to automate obtaining the desired output; wherein at least some of the training data entries in the training data were obtained by performing the steps comprising: capturing, using one or more sensors configured in a work setting, sensor data comprising one or more values about an element which is used to form the input data about the element; and associating ground-truth data with input data, in which the ground-truth data is obtained from one or more workers in a course of performing a vocational task in the work setting.

In one or more embodiments, the trained machine learning model may be deployed in a same or similar work setting to automate the vocational task performed by the one or more workers.

In one or more embodiments, responsive to the machine learning model not achieving an accuracy above a threshold value given the existing labelled dataset, additional training data from the same or similar work setting may be obtained to validate the machine learning model and/or to perform additional training on the machine learning model using at least some of the additional training data. In one or more embodiments, responsive to the machine learning model achieving accuracy above the threshold value, it may be deployed in a same or similar work setting to automate the vocational task.

In one or more embodiments, the training data may be obtained from a plurality of work settings, in which workers operate on elements/items that are of a same type and perform a same vocational operation, to obtain a plurality of training datasets.

In one or more embodiments, a plurality of machine learning models formed using different training datasets may be obtained and a set of combined models comprising a combination of two or more of the machine learning models may be formed. Using evaluation data to obtain accuracy measures for each combined model, a combined model with an acceptable accuracy measure may be selected and deployed in at least one of the work settings.

In one or more embodiments, a system comprising one or more communication connections for connecting with one or more sensors, one or more processors, and a non-transitory computer-readable medium or media comprising one or more sets of instructions which, when executed by at least one of the one or more processors, causes steps to perform one or more of the methods discussed above.

Some features and advantages of embodiments of the present invention have been generally described in this summary section; however, additional features, advantages, and embodiments are presented herein or will be apparent to one of ordinary skill in the art in view of the figures, specification, and claims hereof. Accordingly, it should be understood that the scope of the present invention shall not be limited by the particular embodiments disclosed in this summary section.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

FIG. 1 depicts an example production line.

FIG. 2 depicts the production facility of FIG. 1 with the inclusion of sensors to capture the classification process, according to embodiments of the present disclosure.

FIG. 3 depicts an example method for gathering labelled data in a production environment, according to embodiments of the present disclosure.

FIG. 4 graphically depicts sample ground-truth datasets, according to embodiments of the present disclosure.

FIG. 5 depicts an example method for developing a machine learning classification system, according to embodiments of the present disclosure.

FIG. 6 graphically depicts deployed models at various locations, according to embodiments of the present disclosure.

FIG. 7 depicts a methodology for training or retraining a machine learning model, according to embodiments of the present disclosure.

FIG. 8 depicts a methodology for creating a combined machine learning model, according to embodiments of the present disclosure.

FIG. 9 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall also be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” and “comprising” shall be understood to be open terms and any lists the follow are examples and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); and (5) an acceptable outcome has been reached.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

It shall also be noted that although embodiments described herein may be within the context of robot process automation, aspects of the present disclosure are not so limited. Accordingly, the aspects of the present disclosure may be applied or adapted for use in other contexts.

### A. General Introduction

One application of deep learning methods and labelled data is for industrial production applications. For industrial production applications implemented with machine learning/deep learning applications, massive amounts of data is required to train, validate, and/or tune models for better fitting the industrial production line requirements. Typically, data must be labelled with certain tools, but data labelling is not only quite time consuming but also can be extremely expensive. Given the cost for obtaining and labelling data, the costs, in term of the budget for an automation task, may be prohibitive or may potentially slow the production cycle. Also, while human-labelled data is generally high quality, it is not always perfect. The tools used to aid labelling can introduce unexpected issues during human labelling process.

In recent years, researchers, developers, and manufacturer have proposed different approaches for industrial production data labelling.

One approach focuses on the manufacturer collecting raw data during production, which is forwarded to developers. Developers share the raw data with machine learning researchers, who review the data and work with developers to try to label the data. This approach is costly both in terms of time and budget; it also requires trained professional workers to be involved with possible mistakes that may be made at the various stages.

Another approach has the developers collect raw data during production and then review it with researcher to parse the data before using a data labelling service. This process bypasses the production workers and can be challenging to do because of production lines' availability.

Yet another approach involves the researchers collecting data during production. This approach is not efficient because the machine learning researchers are too far removed from real-world application environment. Their talents are better spent development robust and exact machine learning models.

Regardless of who is driving the data collection, the approaches discussed above follow the traditional data labelling processes and do not address the basic problems.

In contrast to the above-mentioned methods, embodiments herein provide adaptable processes that overcome the above-stated drawbacks. Embodiments herein provide data labelling methods for industrial productions based on an RPA (Robotic Process Automation) concept. Embodiments solve the problems mentioned above, achieve the data labelling goals, as well as keep improving the data labelling quality during the production process. Some of the novelties of the embodiments herein include, but are not limited to: taking advantage of the production process to label and collect data, which save time and money and improves accuracy; preventing or reducing the need for worker training costs and human mistake-triggered data labelling problems; and improves data labelling quality and speeds-up of the development cycle.

### B. Method Embodiments

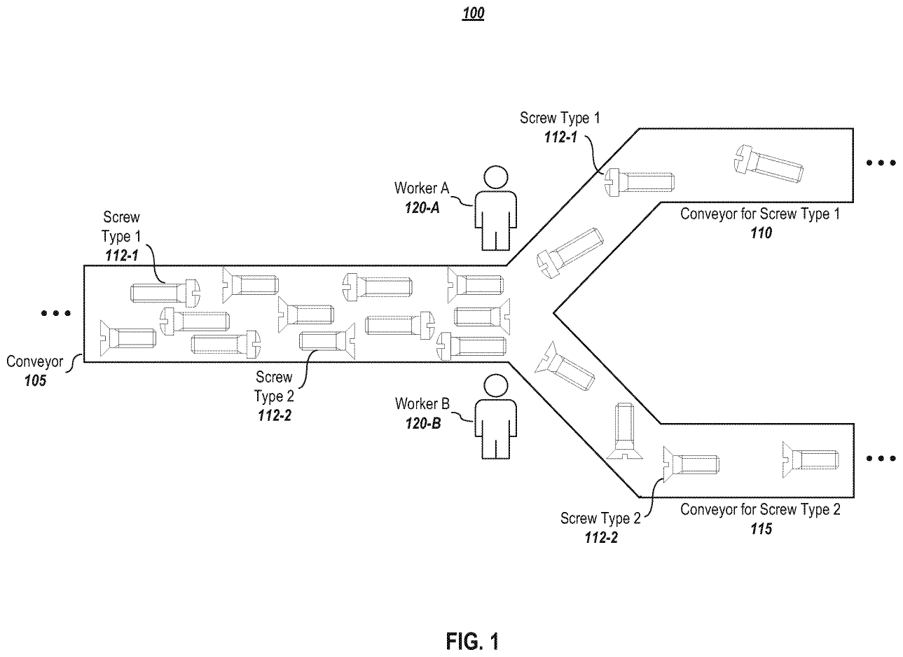

Consider, by way of illustration and not limitation, the follow production example. FIG. 1 depicts an example production line. In the depicted example, a conveyor 105 includes a number of parts—screws 112 of two types. Screw type 1 112-1 is a fillister-type screw, and screw type 2 112-2 is a countersunk-type screw.

During the normal industrial production process, workers (e.g., worker A 120-A and worker B 120-B) operating at the production facility are tasked with sorting the parts. They are tasked with classify the screws on the main conveyor 105 into to the two different groups. Screws of type 1 are placed on one branch of a conveyor 110, and screws of type 2 are placed on another branch of the conveyor 115.

This sorting action is actually an inference execution, as well as a data labelling process. Workers separating the two screw types into their different groups is not only a form of parts classification model inference but also labelling of the data (i.e., the elements of interest) into the screw types. These workers, who do this classification/sorting task as their vocation, are skilled experts. Embodiments herein leverage these workers' expertise by capturing the workers' operation (classifying the screws) during the normal production process and saving this data, which is labelled data.

### 1. Dataset Generation Embodiments

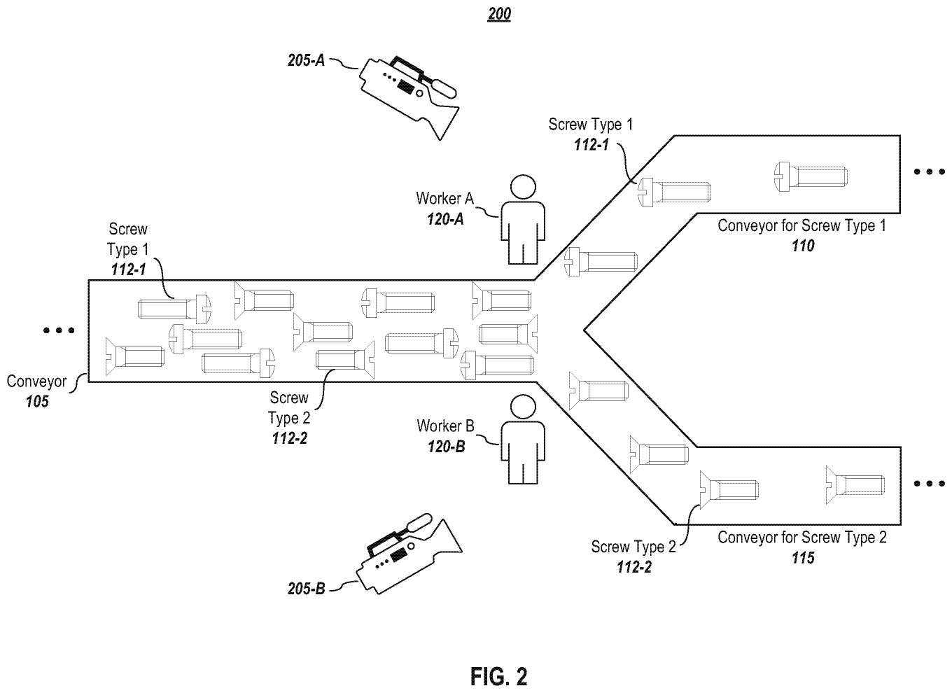

FIG. 2 depicts the production facility of FIG. 1 with the inclusion of sensors to capture the classification process, according to embodiments of the present disclosure. As depicted, the facility 200 has two sensor devices, in this case cameras 205-A and 205-B, added to the production line. One camera, camera 205-A, captures images of the screws on the conveyor 110 after the workers 120 have sorted them. Note that all of these screws, due to the expert sorting of the workers, are of the same screw type (screw type 1). Similarly, the other camera, camera 205-B, captures images of the screws on the conveyor 115 after the workers 120 have sorted them. Note that all of these screws are of the other screw type (screw type 2). Note that a result of the captured images is a set of image data with the screws in various position (which improves data robustness) but with correct labels.

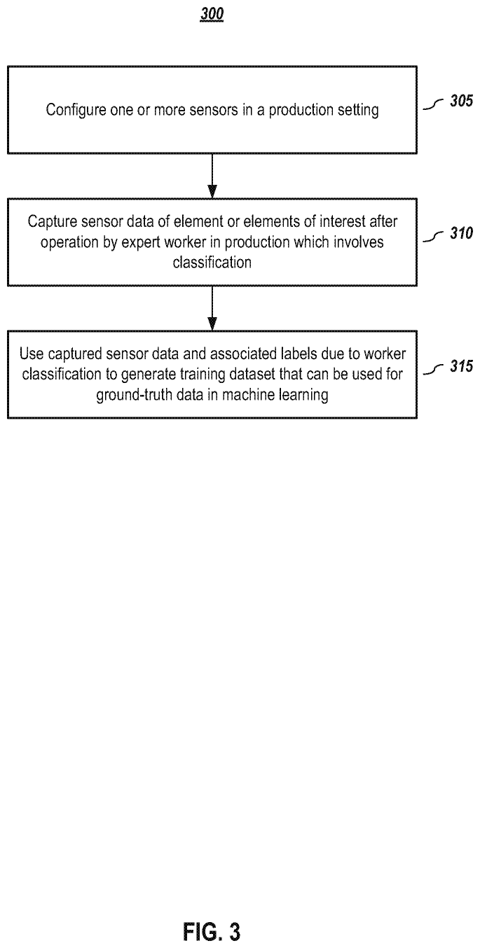

FIG. 3 depicts an example method for gathering labelled data in a production environment, according to embodiments of the present disclosure. In one or more embodiments, a person, such as a developer or manufacturer, may configure or add (305) one or more sensors in a production setting. In this example, the sensors are cameras that capture images, but it should be noted that other sensors may be used and that multiple types of sensor data may be captured (e.g., weight, color, surface condition, sound, resistance, conductivity, temperature, etc.). During normal operation of the production, the sensor device or devices capture (310) sensor data of the element or elements of interest after operation by expert worker(s) in production which involves classification. As noted above, in this example, the cameras capture images of the screws on the different branches of the conveyors after having been sorted. The captured sensor data and associated labels due to worker classification may be used to generate training dataset that can be used for ground-truth data in machine learning.

Consider, by way of illustration, the sets of image data from the camera. Dataset 405 comprises the images of the screws from one camera, camera A 205-A in this example. Since it is known that the screws from camera A are of screw type 1, they can be associated with a label, in this case “Type 1” to represent that they are screws of class “Type 1.” Similarly, dataset 410 comprises the images of the screws from the other camera, camera B 205-B. Since it is known that the screws from camera B are of screw type 2, they can be associated with the appropriate—“Type 2” to represent that they are screws of class “Type 2.”

Furthermore, in one or more embodiments, these two datasets of images and labels may be combined into a single dataset 400 with images and labels to form a training dataset with ground-truth labels. This training dataset may be used to develop a machine learning classification model to duplicate the worker's sorting task.

### 2. Embodiments of Machine Learning Model Development Using the Collected Dataset

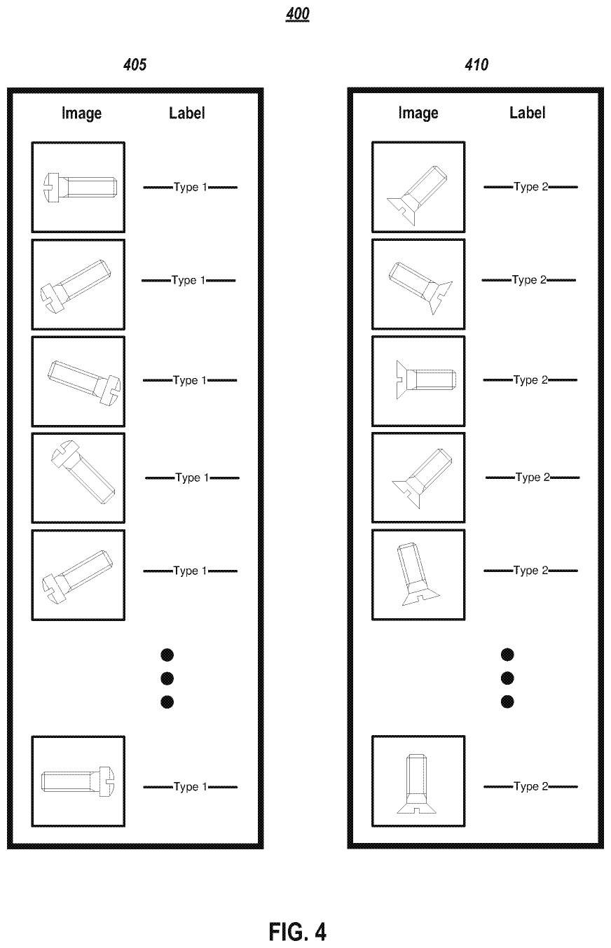

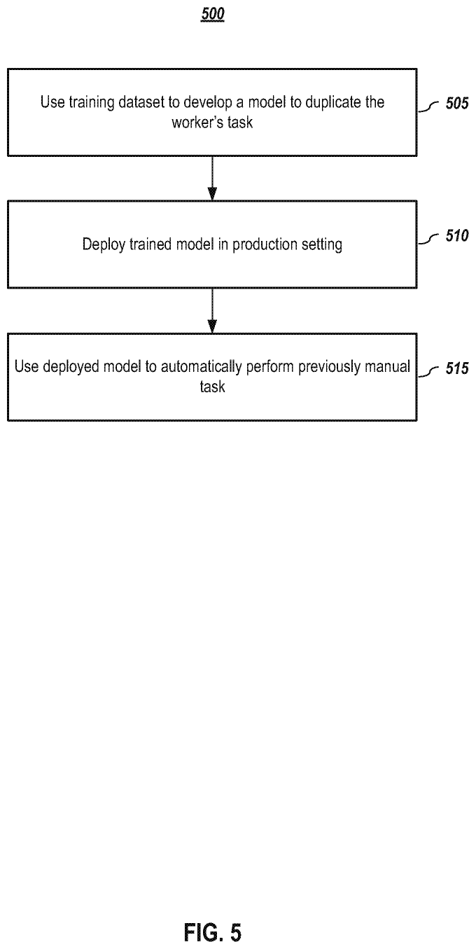

FIG. 5 depicts an example method for developing a machine learning classification system, according to embodiments of the present disclosure. As noted above, one of the biggest challenged historically for a machine learning system, particularly supervised learning methods with deep neural network models, is having vast amounts of accurately labelled data. Given the methodology discussed above, typical production environments may be leveraged to obtain such data, such as dataset 400 of FIG. 4. Given this ground-truth data, a researcher may develop a machine learning model to reproduce the classification task. It should be noted that the training dataset may be divided, as is common in machine learning processes, into subset (e.g., training dataset, validation dataset, test dataset, and tuning dataset). Thus, a researcher may utilize the training data to explore and compare performance of different network architectures, perform ablation studies, and use other machine learning methodologies in search of a well-performing machine learning model. Once trained, the machine learning model may be deployed (515) in the production setting to automate (515) the process previously performed by the workers.

### 3. Embodiments of Model Modification

In one or more embodiments, after deploying the trained model in a production environment, the model may be verified and further optimized. For example, the sensors used to capture the original data may be used to capture addition data to improve the model. In one or more embodiments, the sensors may capture additional expert worker data to use to improve or validate the model, the sensors may capture data of the automated sorted to gauge is accuracy (e.g., its precision and recall), or both. The collection of more labelled data introduces a positive pipeline cycle for continuously improving industrial production usage.

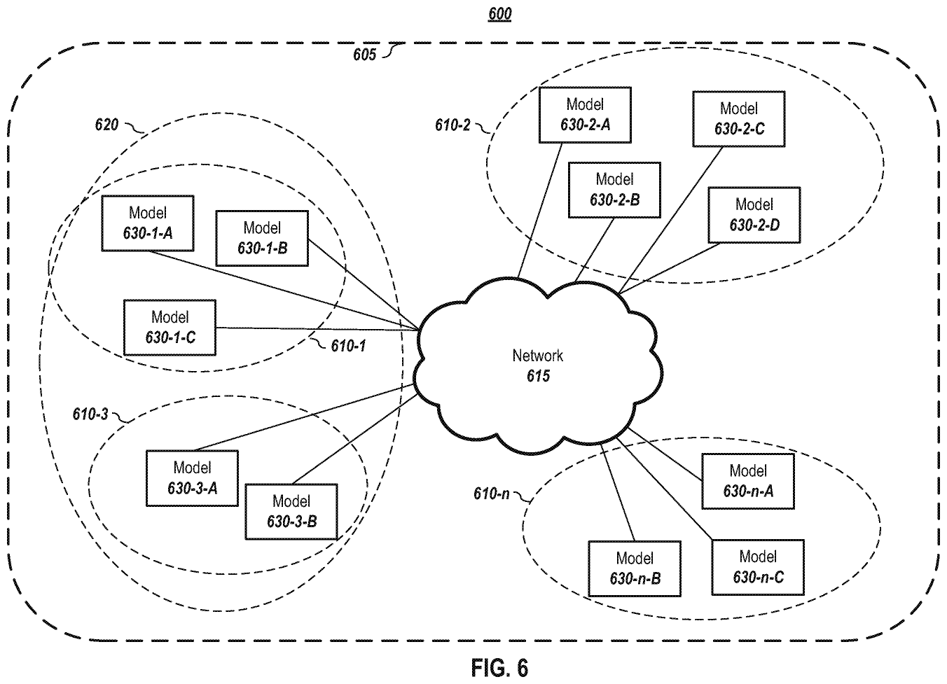

It should also be noted that a company may have a number of production facilities, each of which may have the same or similar operation. Consider, by way of illustration, the facilities depicted in FIG. 6.

FIG. 6 graphically depicts deployed models at various locations, according to embodiments of the present disclosure. As shown in FIG. 6, a number of model 630-n-x operating on computing systems, which may be communicatively connected via a network 615. The different models may be deployed across a vast or relatively small area 605.

In one or more embodiments, each model 630-n-x is deployed at a facility location 610-n, and, in one or more embodiments, a facility location may exist in a region (e.g., region 620). The different regions may represent regions in which the sensor data may collect information that has one or more common characteristics, such as environmental conditions (e.g., lighting, production layout, etc.), tasks, etc.

In one or more embodiments, each model 630-n-x may have been trained using data collected using sensor data collected from the same facility or location at which the model is ultimately deployed. A benefit of doing this specific data collection is that variations in production layout or conditions can be accounted for. It should be noted that because of the low cost and ease for collecting labelled data using embodiments herein, it is not cost prohibitive to collect such granular data. It should also be noted that these various sets of data may also be leveraged to train other models or to improve robustness of models.

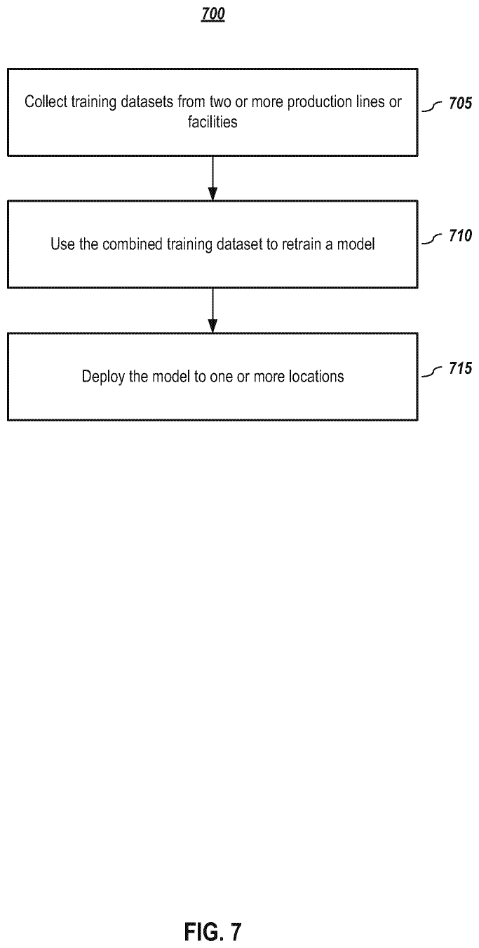

FIG. 7 depicts a methodology for training or retraining a machine learning model, according to embodiments of the present disclosure. In one or more embodiments, a central computing system/cloud computing system (not shown in FIG. 6) may collect (705) training datasets from two or more production facilities 610 or production line instances. For example, the ground-truth dataset obtained for locations for the models 630-1-A, 630-1-B, 630-1-C, 630-3-A, and 630-3-B may be collected. These ground-truth datasets may be combined, and these collected trained sets, in whole or in part, may be used to update/retrain (710) a neural network model. This model, after training or updating, may be deployed (715) to one or more locations. It should be noted that, given potential variance in the data, the models may be made more robust.

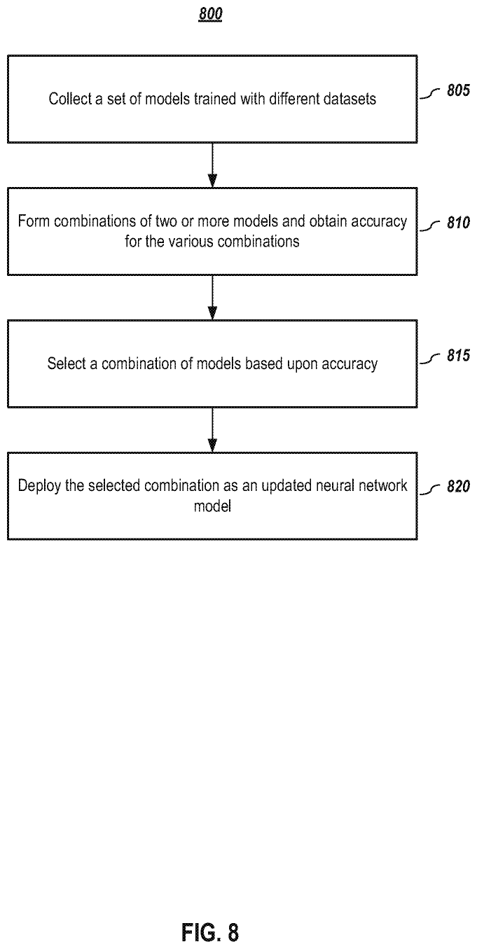

In one or more embodiments, such a model may be deployed to a selected location or may be deployed to all locations. In one or more embodiments, different versions of the model may develop and may be combined or ensembled to make a model that is more accurate and/or more robust. Consider, for example, the method depicted in FIG. 8.

In one or more embodiments, retraining/updating a machine learning model may comprise simply retraining it with more data as discussed above. However, in one or more embodiments, updating the model may comprise changing or supplementing the model itself. For example, FIG. 8 depicts a methodology for creating a combined neural network, according to embodiments of the present disclosure. In one or more embodiments, a set of retrained or updated models may be collected. For example, a set of original, retrained, and/or updated machine learning models may be collected (805) via a network (e.g., network 615 in FIG. 6). In one or more embodiments, the collected models may be combined (810) in a set of combination models, in which each combination comprises two or more models, and the accuracies of the various combinations are obtained using, for example, ground-truth data collected as discussed above. In one or more embodiments, the combinations of models may be achieved by using an ensemble in which, for an input, the output of a neural network of the combination that has the highest inference probability is selected. Alternatively, or additionally, the inference probability of the combined neural network may be combined to determine a final output. Alternatively, or additionally, the labelled data may be combined and merged, and various models retrained using the data (or at least a portion thereof), and the model with the best accuracy/performance is selected.

In one or more embodiments, the model, which may be a combination model, that achieved the best accuracy may be selected (815) as the updated model, and the selected model may be deployed as an updated model at one or more production locations.

### C. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, stylus, touchscreen and/or video display. The computing system may also include one or more buses operable to transmit communications between the various hardware components.

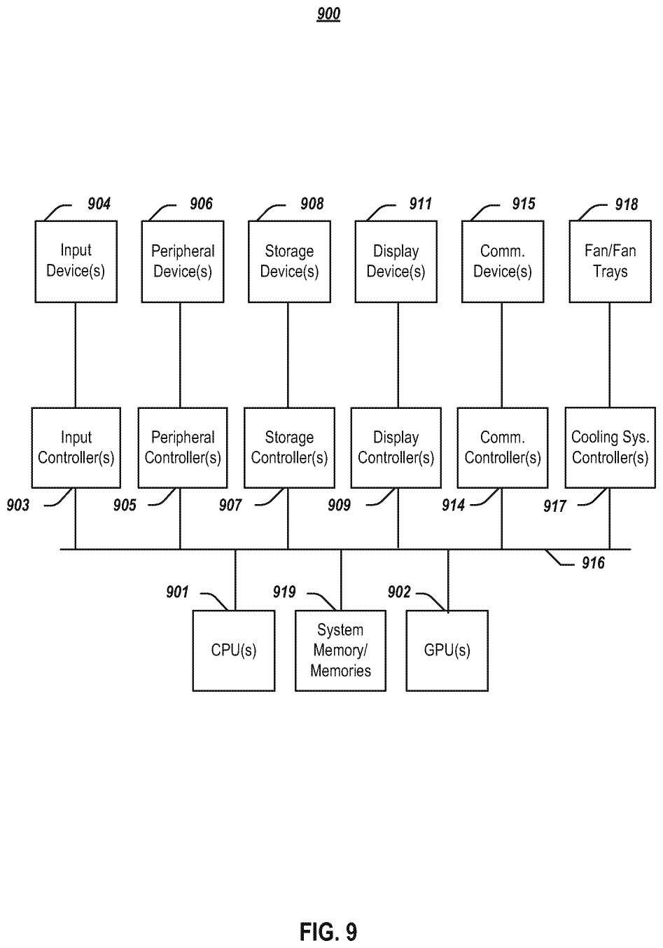

FIG. 9 depicts a simplified block diagram of an information handling system (or computing system), according to embodiments of the present disclosure. It will be understood that the functionalities shown for system 900 may operate to support various embodiments of a computing system—although it shall be understood that a computing system may be differently configured and include different components, including having fewer or more components as depicted in FIG. 9.

As illustrated in FIG. 9, the computing system 900 includes one or more central processing units (CPU) 901 that provides computing resources and controls the computer. CPU 901 may be implemented with a microprocessor or the like, and may also include one or more graphics processing units (GPU) 902 and/or a floating-point coprocessor for mathematical computations. In one or more embodiments, one or more GPUs 902 may be incorporated within the display controller 909, such as part of a graphics card or cards. Thy system 900 may also include a system memory 919, which may comprise RAM, ROM, or both.

A number of controllers and peripheral devices may also be provided, as shown in FIG. 9. An input controller 903 represents an interface to various input device(s) 904, such as a keyboard, mouse, touchscreen, and/or stylus. The computing system 900 may also include a storage controller 907 for interfacing with one or more storage devices 908 each of which includes a storage medium such as magnetic tape or disk, or an optical medium that might be used to record programs of instructions for operating systems, utilities, and applications, which may include embodiments of programs that implement various aspects of the present disclosure. Storage device(s) 908 may also be used to store processed data or data to be processed in accordance with the disclosure. The system 900 may also include a display controller 909 for providing an interface to a display device 911, which may be a cathode ray tube (CRT) display, a thin film transistor (TFT) display, organic light-emitting diode, electroluminescent panel, plasma panel, or any other type of display. The computing system 900 may also include one or more peripheral controllers or interfaces 905 for one or more peripherals 906. Examples of peripherals may include one or more printers, scanners, input devices, output devices, sensors, and the like. A communications controller 914 may interface with one or more communication devices 915, which enables the system 900 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 900 comprises one or more fans or fan trays 918 and a cooling subsystem controller or controllers 917 that monitors thermal temperature(s) of the system 900 (or components thereof) and operates the fans/fan trays 918 to help regulate the temperature.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, for example: magnetic media such as hard disks, floppy disks, and magnetic tape; optical media such as compact disc (CD) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as a CD and holographic devices; magneto-optical media; and hardware devices that are specially configured to store or to store and execute program code, such as ASICs, programmable logic devices (PLDs), flash memory devices, other non-volatile memory (NVM) devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

1. A method comprising:
for each element of a plurality of elements of interest:
capturing, using one or more sensors configured in a work setting, sensor data comprising one or more values of the element of interest; and
associating a classification label with the element of interest, in which the classification label is determined by one or more workers in a course of the one or more workers performing their normal duties in the work setting; and
forming a labelled dataset using the captured sensor data and associated labels from the one or more workers' classifications for the plurality of elements of interest.

2. The method of claim 1 further comprising:
using at least some of the labelled dataset to train a machine learning model to perform classification on elements of interest.

3. The method of claim 2 further comprising:
deploying the trained machine learning model in a same or similar work setting to automate classification of elements of interest.

4. The method of claim 2 further comprising:
responsive to the machine learning model not achieving an accuracy above a threshold value given an existing labelled dataset:
repeating the steps of claim 1 to obtain additional labelled data to validate the machine learning model; and
performing additional training on the machine learning model using at least some of the additional labelled data; and
responsive to the machine learning model achieving accuracy above the threshold value, deploying the trained machine learning model in a same or similar work setting to automate classification of elements of interest.

5. The method of claim 1 further comprising:
repeating the steps of claim 1 at a plurality of work settings, in which workers operate on elements of interest that are of a same type and perform a same classification operation, to obtain a plurality of labelled datasets using the captured sensor data and associated labels from the one or more worker's classifications.

6. The method of claim 5 further comprising:
for each work setting of a set of work settings selected from the plurality of work settings, using at least some of the labelled dataset associated with the work setting to train a machine learning model to perform classification on elements of interest.

7. The method of claim 6 further comprising:
obtaining a plurality of machine learning models formed using different labelled datasets;
forming a set of combined models comprising a combination of two or more of the machine learning models;
using evaluation data to obtain accuracy measures for each combined model;
selecting a combined model with an acceptable accuracy measure; and
deploying the combined model at least one of the work settings.

8. The method of claim 6 further comprising:
combining labelled data from at least two work settings.

9. A method for training a machine learning model, the method comprising:
obtaining training data comprising, for each training data entry, input data about an element and corresponding ground-truth data for a desired output; and
using the training data to train a machine learning model to operate on input data corresponding to the data about an element to automate obtaining the desired output;
wherein at least some of the training data entries in the training data were obtained by performing the steps comprising:
capturing, using one or more sensors configured in a work setting, sensor data comprising one or more values about an element which is used to form the input data about the element; and
associating ground-truth data with input data, in which the ground-truth data is obtained from one or more workers in a course of performing a vocational task in the work setting.

10. The method of claim 9 further comprising:
deploying the trained machine learning model in a same or similar work setting to automate the vocational task performed by the one or more workers.

11. The method of claim 10 further comprising:
responsive to the machine learning model not achieving an accuracy above a threshold value given an existing labelled dataset:
obtaining additional training data from the same or similar work setting to validate the machine learning model; and
performing additional training on the machine learning model using at least some of the additional training data; and
responsive to the machine learning model achieving accuracy above the threshold value, deploying the trained machine learning model in a same or similar work setting to automate the vocational task.

12. The method of claim 10 wherein the training data was obtained from a plurality of work settings, in which workers operate on elements that are of a same type and perform a same vocational task, to obtain a plurality of training datasets.

13. The method of claim 12 further comprising:
for each work setting of a set of work settings selected from the plurality of work settings, using at least some of the training data associated with the work setting to train a machine learning model to perform the vocational task.

14. The method of claim 13 further comprising:
obtaining a plurality of machine learning models formed using different training datasets;
forming a set of combined models comprising a combination of two or more of the machine learning models;
using evaluation data to obtain accuracy measures for each combined model;
selecting a combined model with an acceptable accuracy measure; and
deploying the combined model at least one of the work settings.

15. The method of claim 12 further comprising:
combining training dataset from at least two work settings to form a single training dataset.

16. A system comprising:
a first computing system comprising:
one or more communication connections for connecting with one or more sensors;
one or more processors; and
a non-transitory computer-readable medium or media comprising one or more sets of instructions which, when executed by at least one of the one or more processors, causes steps to be performed comprising:
for each element of a plurality of elements of interest:
receiving data captured using at least one of the one or more sensors, which are configured in a work setting, sensor data comprising one or more values of the element of interest; and
associating a classification label with the element of interest, in which the classification label is determined by one or more workers in a course of the one or more workers performing their normal duties in the work setting; and
forming a labelled dataset using the captured sensor data and associated labels from the one or more workers' classifications for the plurality of elements of interest.

17. The system of claim 16 further comprising:
using at least some of the labelled dataset to train a machine learning model to perform classification on elements of interest.

18. The system of claim 16 wherein the labelled data was obtained from a plurality of work settings, in which workers operate on elements that are of a same type and perform a same vocational task, to obtain a plurality of training datasets.

19. The system of claim 18 wherein the non-transitory computer-readable medium or media further comprises one or more sets of instructions which, when executed by at least one processor, causes steps to be performed comprising:
for each work setting of a set of work settings selected from the plurality of work settings, using at least some of the labelled data associated with the work setting to train a machine learning model to perform the vocational task.

20. The system of claim 19 wherein the non-transitory computer-readable medium or media further comprises one or more sets of instructions which, when executed by at least one processor, causes steps to be performed comprising:
obtaining a plurality of machine learning models formed using different training datasets;
forming a set of combined models comprising a combination of two or more of the machine learning models;
using evaluation data to obtain accuracy measures for each combined model;
selecting a combined model with an acceptable accuracy measure; and
deploying the combined model at least one of the work settings.

21. A non-transitory computer readable storage medium storing a computer program executable to cause one or more processors to cause steps to be performed comprising:
for each element of a plurality of elements of interest:
capturing, using one or more sensors configured in a work setting, sensor data comprising one or more values of the element of interest; and
associating a classification label with the element of interest, in which the classification label is determined by one or more workers in a course of the one or more workers performing their normal duties in the work setting; and
forming a labelled dataset using the captured sensor data and associated labels from the one or more workers' classifications for the plurality of elements of interest.

22. A computer program product, comprising a program stored on a computer-readable storage medium, the program comprising program instructions executable to cause one or more processors to cause steps to be performed comprising
for each element of a plurality of elements of interest:
capturing, using one or more sensors configured in a work setting, sensor data comprising one or more values of the element of interest; and
associating a classification label with the element of interest, in which the classification label is determined by one or more workers in a course of the one or more workers performing their normal duties in the work setting; and
forming a labelled dataset using the captured sensor data and associated labels from the one or more workers' classifications for the plurality of elements of interest.
